(19) United States
(12) Patent Application Publication
(10) Pub. No.: US 2006/0137717 A1
(43) Pub. Date: Jun. 29, 2006

(54) Method for removing impurities grown on a phase shift mask

(75) Inventor: Jun Sik Lee, Chungecheongbuk-do (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hynix Semiconductor Inc., Seoul (KR)

(21) Appl. No.: 11/292,501

(22) Filed: Dec. 1, 2005

(30) Foreign Application Priority Data
Dec. 27, 2004 (KR) 2004-113239

(51) Int. Cl. B08B 7/00; B08B 3/00

(52) U.S. Cl. 134/19; 134/28

(57) ABSTRACT

A method for removing impurities grown on a phase shift mask. The method can advantageously control growth of impurities by further performing HF cleaning and baking after cleaning to minimize the amount of residual chemical ions generated during cleaning. Specifically, the method comprises forming a phase shift mask pattern including a phase shift film and a light-blocking film on a quartz substrate, cleaning the phase shift mask pattern formed on the quartz substrate using a solution containing sulfuric acid ions or ammonium ions, cleaning the cleaned phase shift mask pattern using an aqueous HF solution, and baking the phase shift mask pattern cleaned with the aqueous HF solution.

### BACKGROUND OF THE INVENTION

1. Field of the Invention

The present invention relates to a method for removing impurities grown on a phase shift mask, and more particularly to a method for controlling growth of impurities by further performing HF cleaning and baking after cleaning to minimize the amount of residual chemical ions generated during cleaning.

2. Description of the Related Art

In recent years, the high integration of semiconductor devices has resulted in a reduction in the size of patterns formed on wafers. Photolithography using photomasks is employed to form fine patterns' on wafers. Half-tone phase shift masks made of a phase shift material having a light transmittance of several percent (%), such as molybdenum silicon oxynitride (MoSiON), are currently used. Half-tone phase shift masks use destructive interference between light passed through a phase shift material and light passed through a quartz substrate to form a relatively fine pattern on a wafer.

Hereinafter, a conventional method for producing a half-tone phase shift mask and a cleaning process will be explained with reference to the accompanying drawings.

FIGS. 1a to 1d are cross-sectional views illustrating the procedure of a conventional method for producing a half-tone phase shift mask.

As shown in FIG. 1a, a phase shift film 11, a light-blocking film 12, and a photosensitive film are sequentially formed over the entire surface of a quartz substrate 10. The photosensitive film is exposed to light and developed to form a photosensitive film pattern 13 defining light transmission regions A and to expose the light-blocking film 12. The phase shift film 11 contains MoSiON, and the light-blocking film 12 contains chromium (Cr).

As shown in FIG. 1b, the light-blocking film 12 and the phase shift film 11 are sequentially etched using the photosensitive film pattern 13 as an etch mask to form light transmission regions A and to remove the photosensitive film pattern 13. The etching of the light-blocking film 13 and the phase shift mask 12 is performed using a mixed gas of a fluorine-based gas, such as CF₄, SF₄ or CHF₃, O₂, and He or Ar gas by plasma dry etching.

As shown in FIG. 1c, portions of the light-blocking film 12 within phase shift regions B are removed to form a half-tone phase shift mask pattern.

As shown in FIG. 1d, cleaning is performed to remove chemical residues generated during etching of the phase shift film 11 and the light-blocking film 12. Specifically, cleaning is performed in accordance with the following procedure. First, the phase shift mask having the pattern formed thereon is mounted on a loader. A solution containing sulfuric acid ions is used to remove residues of the photosensitive film pattern. Next, a solution containing ammonium ions is used to clean off chemical residues and organic substances, and a highly volatile isopropyl alcohol (IPA) is used to evaporate any moisture present on the surface of the phase shift mask (isopropyl alcohol vapor drying). Finally, the phase shift mask is transferred to an unloader.

However, the sulfuric acid ions or ammonium ions may remain on the mask surface after cleaning, which causes some problems, e.g., growth of impurities, depending on the changes in mask production circumstances and exposure doses of an exposure apparatus. Particularly, since the ammonium ions react with the sulfuric acid ions to form salts, the density of the grown impurities increases linearly with the passage of time and thus the impurities prevent the action of the mask.

### SUMMARY OF THE INVENTION

Embodiments of the present invention provide methods for controlling growth of impurities by further performing HF cleaning and baking after cleaning to minimize the amount of residual chemical ions generated during cleaning.

In accordance with one embodiment of the present invention, a method for removing impurities grown on a phase shift mask comprises forming a phase shift mask pattern including a phase shift film and a light-blocking film on a quartz substrate, cleaning the phase shift mask pattern formed on the quartz substrate using a solution containing sulfuric acid ions or ammonium ions, cleaning the cleaned phase shift mask pattern using an aqueous HF solution, and baking the phase shift mask pattern cleaned with the aqueous HF solution.

In one embodiment of the present invention, the solution containing sulfuric acid ions or ammonium ions is an SPM or SC-1 solution.

The aqueous HF solution used in the HF cleaning may consist of HF and water in a mixing ratio ranging from 100:1 to 500:1.

The baking step can be carried out using a hot plate.

Furthermore, baking may be conducted at 400° C. for 5 minutes while N₂ gas is supplied at a flow rate of 3 sccm.

In accordance with one embodiment of the present invention, the baking is conducted while a gas, e.g., He, is injected into the back surface of the mask on which the phase shift mask pattern is formed.

### BRIEF DESCRIPTION OF THE DRAWINGS

Embodiments of the present invention will be more clearly understood from the following detailed description taken in conjunction with the accompanying drawings, in which:

FIGS. 1a to 1d are cross-sectional views illustrating the procedure of a conventional method for producing a half-tone phase shift mask;

FIGS. 2a to 2e are cross-sectional views illustrating the procedure of a method for removing impurities grown on a phase shift mask according to an embodiment of the present invention; and

FIG. 3 is a graph showing changes in the etching rate of a quartz substrate and a phase shift mask according to the changes in the dilution ratio of a hydrofluoric (HF) solution.

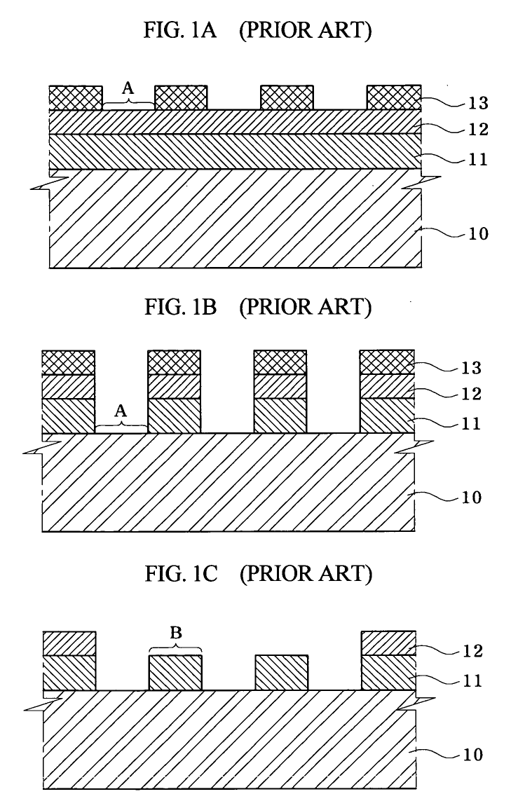

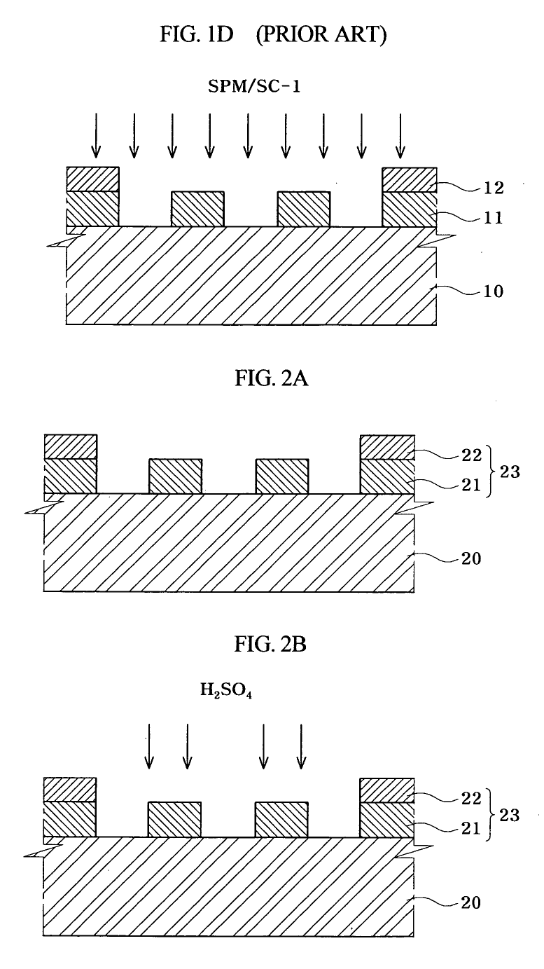

### DESCRIPTION OF THE EMBODIMENTS

Embodiments of the present invention will now be described in detail with reference to the accompanying drawings. However, these embodiments can be variously modified and are not to be construed as limiting the scope of the invention.

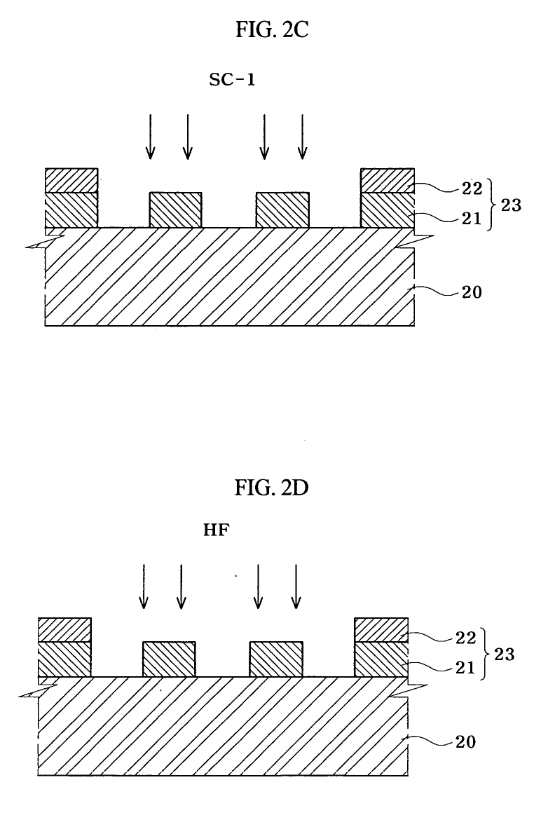

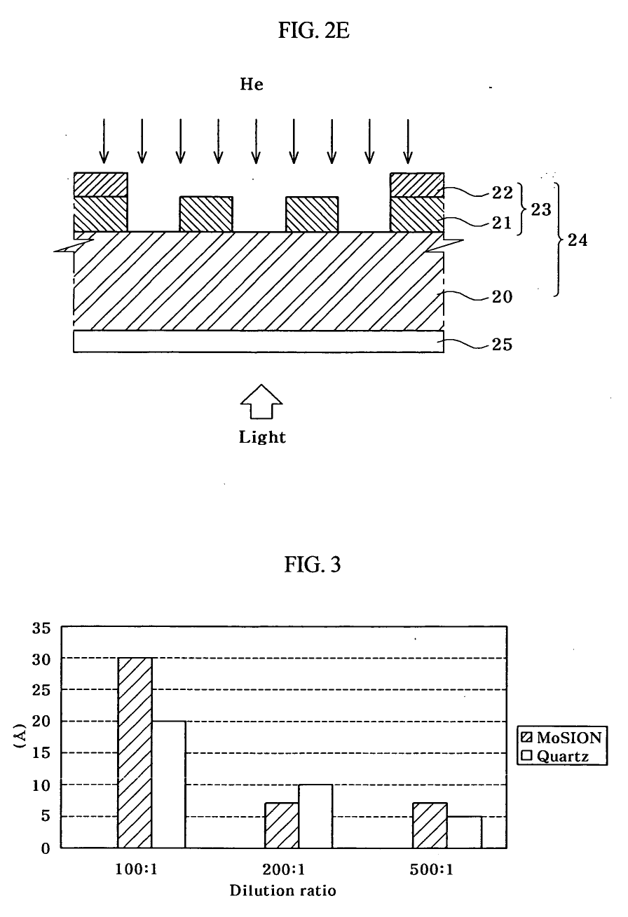

FIGS. 2a to 2e are views illustrating the procedure of a method for removing impurities grown on a phase shift mask according to an embodiment of the present invention.

As shown in FIG. 2a, a structure including a light-blocking film, a phase shift film, and a photosensitive film formed on a quartz substrate is exposed to an e-beam, and developed to form a photosensitive film pattern defining light transmission regions. As a result, a fine pattern is formed from the photosensitive film pattern. Specifically, the light-blocking film and the phase shift film are etched by dry etching to form a phase shift mask pattern 23 including the phase shift film 21 and the light-blocking film 22 formed on the quartz substrate 20.

As shown in FIG. 2b, a solution containing sulfuric acid ions is used to remove organic contaminants, such as the photosensitive film, remaining on the phase shift mask pattern 23. It should be appreciated that a solution containing sulfuric acid ions such as a SPM solution (H₂SO₄+H₂O₂) of sulfuric acid and hydrogen peroxide (H₂O₂) can be used. Cleaning with the SPM solution allows the formation of a chemical oxide film on the substrate, making the surface of the quartz substrate hydrophilic and permitting other cleaning solutions to easily act on the mask.

As shown in FIG. 2c, the phase shift mask pattern 23, from which the photosensitive film pattern is removed, is cleaned using a solution containing ammonium ions. In one embodiment of the present invention, a type of solution containing ammonium ions, e.g., a SC-1 (Standard Clean-1) solution containing ammonia (NH₃), hydrogen peroxide (H₂O₂), and water (H₂O), may have a respective mixing ratio of 1:1:5. The cleaning may be performed at 75˜90° C. for 10˜20 minutes. The hydrogen peroxide (H₂O₂) decomposes into water (H₂O) and oxygen (O₂) during cleaning and converts organic substances remaining on the mask surface into a highly water-soluble composite substance due to its strong oxidative activity. Chemical residues that are not removed by the action of the SPM solution are removed by the oxidation of the hydrogen peroxide and dissolution and etching of the ammonia solution (NH₄OH).

As shown in FIG. 2d, after completion of the cleaning with the SPM solution and the SC-1 solution, additional cleaning is performed using an aqueous HF solution, followed by rinsing with water. Subsequently, isopropyl alcohol vapor drying is performed using highly volatile isopropyl alcohol (IPA) to remove moisture present on the surface of the phase shift pattern.

The cleaning with an aqueous HF solution can be performed using a diluted hydrofluoric (DHF) solution in which water and a hydrofluoric (HF) solution are mixed at a ratio of 100-500:1. The diluted hydrofluoric (DHF) solution can be used to etch the surface of the quartz substrate and the phase shift mask of the phase shift mask pattern. This etching can remove residual chemical ions remaining on the surface of the quartz substrate and the phase shift mask. Detailed description thereof will be explained in more detail with reference to FIG. 3.

FIG. 3 is a graph showing changes in the etch rate of the quartz substrate and the phase shift mask according to the changes in the dilution ratio of the hydrofluoric (HF) solution. Referring to FIG. 3, when the dilution ratio of the water to the hydrofluoric solution is less than 100:1, deep etching occurs and the transmittance of the phase shift mask increases. When the dilution ratio exceeds 500:1, impurities remaining on the phase shift mask pattern may not be readily removed.

As shown in FIG. 2e, after the cleaning with the aqueous HF solution, baking is performed on the phase shift mask pattern 23. The baking can be performed using a hot plate 25. At this step, the hot plate 25 is positioned on the front surface of the mask 24 on which the phase shift mask pattern is formed. In one embodiment of the present invention, mask 24 is irradiated with light at a wavelength of 193 nm and supplied with N₂ gas to maintain the temperature constant and keep the surroundings clean. The baking is performed at 400° C. for 5 minutes while the N₂ gas is supplied at a flow rate of 3 sccm.

While the hot plate 25 is exposed to light having 193 nm to supply energy thereto, a helium (He) gas, a cooling medium, or the like is supplied to the back surface of the mask on which the phase shift mask pattern 23 is formed to prevent the quartz substrate 20 from being distorted. In addition, chemical residual gases evolved from the surface of the quartz substrate 20, the phase shift mask 21, and the light-blocking film 22 upon light exposure are discharged through an exhaust port.

In one embodiment of the present invention, the baking using the hot plate decreases the amount of remaining sulfuric acid ions and ammonium ions to about one half of the initial amount of the ions.

A method in accordance with an embodiment of the present invention comprises forming a phase shift mask pattern including a phase shift film and a light-blocking film on a quartz substrate and cleaning the phase shift mask using an SPM solution and an SC-1 solution.

According to a method of the present invention, after completion of the cleaning with an SPM solution and an SC-1 solution, HF cleaning and baking are further performed to minimize the amount of residual chemical ions, such as sulfuric acid ions and ammonium ions, generated during the cleaning, thereby controlling growth of impurities on the phase shift mask, and as a result, preventing the formation of defects in the phase shift mask.

As apparent from the above description, according to the method of the present invention, after cleaning, HF cleaning is further performed to remove chemical residues remaining on the surface of the quartz substrate and the phase shift film, thereby controlling growth of impurities on the phase shift mask.

In addition, baking using a hot plate is further performed to decrease the amount of chemical ions, such as such as sulfuric acid ions and ammonium ions, remaining on the phase shift mask.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for removing impurities grown on a phase shift mask, comprising:
forming a phase shift mask pattern including a phase shift film and a light-blocking film on a mask substrate;
cleaning the phase shift mask pattern formed on the mask substrate using a solution containing sulfuric acid ions or ammonium ions;
cleaning the cleaned phase shift mask pattern using an aqueous HF solution; and
baking the phase shift mask pattern cleaned with the aqueous HF solution.

2. The method according to claim 1, wherein the solution containing sulfuric acid ions or ammonium ions is a SPM (H₂SO₄+H₂O₂) or a SC-1 (Standard Clean-1) solution.

3. The method according to claim 1, wherein the aqueous HF solution includes HF and water in a mixing ratio ranging from 100:1 to 500:1.

4. The method according to claim 1, wherein the baking step is carried out using a hot plate.

5. The method according to claim 1, wherein the baking is conducted at 400° C. for 5 minutes while N₂ gas is supplied at a flow rate of 3 sccm.

6. The method according to claim 5, wherein the baking is conducted while a gas, including He, is injected into a back surface of the mask on which the phase shift mask pattern is formed.
